(19) United States
(12) Patent Application Publication
(10) Pub. No.: US 2014/0355440 A1
(43) Pub. Date: Dec. 4, 2014

(54) METHOD AND APPARATUS FOR BANDWIDTH ALLOCATION IN NETWORK TO ENHANCE BALANCE THEREOF

(71) Applicant: Electronics and Telecommunications Research Institute, Daejeon (KR)

(72) Inventors: Kyoung-Soon KANG, Daejeon (KR); Kyeong Ho LEE, Daejeon (KR); Byungjun AHN, Daejeon (KR); Ki Cheol JEON, Daejeon (KR); Hea Sook PARK, Daejeon (KR)

(73) Assignee: Electronics and Telecommunications Research Institute, Daejeon (KR)

(21) Appl. No.: 13/955,795

(22) Filed: Jul. 31, 2013

(30) Foreign Application Priority Data
Jun. 4, 2013 (KR) 10-2013-0064110

(51) Int. Cl. H04L 12/851

(52) U.S. Cl. CPC H04L 47/24
USPC 370/235

(57) ABSTRACT

An apparatus for allocating a network bandwidth includes an information collection unit configured to collect flow information of a network; and a traffic check unit configured to check traffic of the collected flow information. Further, the apparatus includes a traffic respond unit configured to suppress the network bandwidth depending on a check result of the traffic; and a control unit configured to the information collection unit, the traffic check unit, and the traffic respond unit.

### CROSS-REFERENCE TO RELATED APPLICATION(S)

The present invention claims priority of Korean Patent Application No. 10-2013-0064110, filed on Jun. 4, 2013, which is incorporated herein by reference.

### FIELD OF THE INVENTION

The present invention relates to a bandwidth allocation (control) of a network, and more particularly, to a method and apparatus for allocating bandwidth of a network to a plurality of users on a basis of balance by suppressing excessive traffic of a particular user in a transmission apparatus such as a router or switch.

### BACKGROUND OF THE INVENTION

Services such as P2P (Peer-to-Peer) programs are used for distribution paths of high-quality video contents and require more bandwidth than usual. In light of the usage of these services, there may occur an excessive traffic concentration phenomenon by particular heavy users. Therefore, users who access later are not allocated network resources or are guaranteed only minimum bandwidth, which makes a difference in the quality of service.

In order to solve such a problem, a method may be used to create a profile for each individual user and provide QoS (Quality of Service) corresponding to the profile. However, this method requires a lot of maintenance cost and has a restriction on the number of the profiles, which leads to a difficult to set a number of users.

### SUMMARY OF THE INVENTION

In view of the above, the present invention provides a method and apparatus for allocating bandwidth of a network, which detects excessive traffic of a specific user in a router or switch stage on an IP network and controls the excessive traffic so that the services requested by other users can be maintained, thereby providing a balance in the usage of the network resources.

An object of the present invention is not limited to those mentioned above; other objects that are not mentioned will be clearly understood from the following description to those of ordinary skill to which this invention belongs.

In accordance with a first aspect of the present invention, there is provided an apparatus for allocating a network bandwidth. The apparatus includes an information collection unit configured to collect flow information of a network; a traffic check unit configured to check traffic of the collected flow information; a traffic respond unit configured to suppress the network bandwidth depending on a check result of the traffic; and a control unit configured to the information collection unit, the traffic check unit, and the traffic respond unit.

Further, the control unit may be configured to control the allocation of the network bandwidth when the amount of traffic is more than a predetermined threshold (TH).

Further, the flow information may include a source IP address, a destination IP address, a source port, a destination port, or a protocol.

Further, the information collection unit may be configured to group the collected flow information on a basis of the source IP address with reference to the collected flow information under a control of the control unit.

Further, the grouped flow information may comprise the number of flows per unit time, the number of bytes per unit time and the number of packets to be transmitted per second.

Further, the information collection unit may be configured to determine whether the source IP address belongs to which of a predetermined white list group, a predetermined black list group, or a general group under the control of the control unit.

Further, the control unit may be configured to, when the source IP address belongs to the white list group, control the traffic respond unit not to perform the suppression of the network bandwidth.

Further, the control unit may be configured to, when the source IP address belongs to the black list group, block the entrance of traffic into the network.

Further, the traffic check unit may be configured to, when the source IP address belongs to the general group, determine whether the number of flows per unit time, the number of bytes per unit time and the number of packets to be transmitted per second exceed its median value under a control of the control unit.

Further, the traffic respond unit may be configured to: when the number of bytes per unit time exceeds the median value as a result of the determination, reduce the amount of traffic from the source IP address up to the median value under the control of the control unit; when the number of flows per unit time exceeds the median value as a result of the determination, suppress the generation of new flows from the source IP address while reducing the amount of existing flows up to the median value under the control of the control unit; and when the number of packets to be transmitted per second exceeds the median value as a result of the determination, determine whether the number of packets to be transmitted per second exceeds a maximum PPS (Packets per Second) for each source IP address.

Further, the traffic respond unit may be configured to, when the number of packets to be transmitted per second exceeds the maximum PPS for each source IP address, inform the possibility of the occurrence of DDoS (Distributed Denial of Service) attack and move the IP source address to the black list group under the control of the control unit.

Further, the traffic respond unit may be configured to, when the number of packets to be transmitted per second is lower than the maximum PPS for each source IP address, reduce the number of packets to be transmitted per second up to the median value.

In accordance with a second aspect of the present invention, there is provided a method for allocating a network bandwidth, allocation apparatus. The method includes determining, in a control unit, whether the amount of traffic is more than a predetermined threshold (TH); grouping, in an information collection unit, flow information on a basis of a source IP address with reference to the flow information; and determining, in the information collection unit, whether the source IP address belongs to which of a predetermined white list group, a predetermined black list group, or a general group.

Further, the determining whether the source IP address belongs to which of groups may comprise: when the source IP address belongs to the white list group, keeping the network traffic as it is; and when the source IP address belongs to the black list group, blocking the entrance of traffic into the network.

Further, the determining whether the source IP address belongs to which of groups may comprise: when the source IP address belongs to the general group, determining, in the traffic check unit, whether the number of bytes per unit time exceeds its median value; and determining whether the number of flows per unit time exceeds its median value; and determining whether the number of packets to be transmitted per second exceeds its median value.

Further, the determining whether the number of bytes per unit time exceeds its median value may comprise, when the number of bytes per unit time exceeds the median value, reducing the amount of traffic up to the median value.

Further, the determining whether the number of flows per unit time exceeds its median value may comprise, when the number of flows per unit time exceeds the median value, suppressing the generation of new flows from the source IP address and reducing the number of existing flows up to the median value.

Further, the determining whether the number of packets to be transmitted per second exceeds its median value may comprise: when the number of packets to be transmitted per second exceeds the median value, determining whether the number of packets to be transmitted per second exceeds a maximum PPS (Packets per Second) for each source IP address.

Further, the determining whether the number of packets to be transmitted per second exceeds the maximum PPS for each source IP address may comprise: when the number of packets to be transmitted per second exceeds the maximum PPS for each source IP address, informing, in a traffic respond unit, a possibility of occurrence of DDoS (Distributed Denial of Service) attacks and moving the source IP address, which incurs the excessive traffic, to the black list group.

Further, the determining whether the number of packets to be transmitted per second exceeds the maximum PPS for each source IP address may comprise, when the number of packets to be transmitted per second is lower than the maximum PPS for each source IP address, reducing the number of packets to be transmitted to the median value up to the median value.

In accordance with an embodiment of the present invention, the method and apparatus for fairly allocating a network bandwidth may fairly allocate a network resource by actively coping with the increase in the amount of network usage for a particular user with some settings and use behaviors of users in comparison to a conventional method to set up a profile for each user. Further, by virtue of this measurement, it is possible to make the reduction of the management costs for the network bandwidth and prevent the network resources from occupying primarily for some users owing to excessive P2P or DDoS (Distributed Denial of Service) attack.

### BRIEF DESCRIPTION OF THE DRAWINGS

The above and other objects and features of the present invention will become apparent from the following description of the embodiments given in conjunction with the accompanying drawings, in which:

FIG. 1 is a block diagram of an apparatus for allocating a network bandwidth to enhance a balance in accordance with an embodiment of the present invention.

FIG. 2 is a configuration of traffic information used in the apparatus for allocating a network bandwidth to enhance a balance shown in FIG. 1; and

FIGS. 3A and 3B are flow charts illustrating a process of allocating a network bandwidth in a network in accordance with the embodiment of the present invention.

### DETAILED DESCRIPTION OF THE EMBODIMENTS

Hereinafter, the embodiments of the present invention will be described in detail with reference to the accompanying drawings which form a part hereof. In the following description of the present invention, if the detailed description of the already known structure and operation may confuse the subject matter of the present invention, the detailed description thereof will be omitted. The following terms are terminologies defined by considering functions in the embodiments of the present invention and may be changed operators intend for the invention and practice. Hence, the terms need to be defined throughout the description of the present invention.

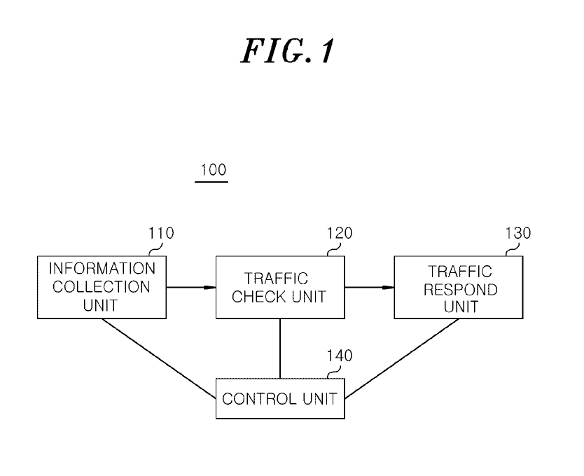

FIG. 1 is a block diagram of an apparatus for allocating a network bandwidth to enhance a balance in accordance with an embodiment of the present invention. An apparatus for allocating a network bandwidth 100 includes an information collection unit 110, a traffic check unit 120, a traffic respond unit 130 and a control unit 140.

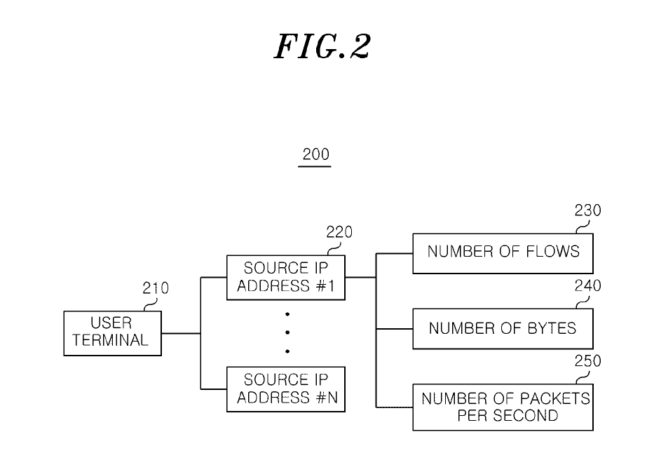

In addition, FIG. 2 is a configuration of traffic information used in the network bandwidth allocation apparatus 100 shown in FIG. 1. As shown in FIG. 2, traffic information 200 used in the network bandwidth allocation apparatus 100 includes information on a user terminal 210, source IP addresses 220 having #1, . . . , #N 220, the number of flows 230, the number of bytes 240 and the number of packets per second 250.

Hereinafter, the operation of the respective components of the network bandwidth allocation apparatus will be described with reference to FIGS. 1 and 2.

First, the control unit 140 controls the information collection unit 110, the traffic check unit 120, and the traffic respond unit 130 to manage an allocation of network bandwidth. The control unit 140 controls the allocation of network bandwidth when the amount of traffic is higher than a predetermined threshold (TH).

The information collection unit 110 collects flow information including a source IP address, a destination IP address, a source port, a destination port, or a protocol, groups the collected flow information on the basis of source IP address with reference to the collected flow information and determines whether the source IP address belongs to which of a white list group, a black list group or a general group. Herein, the grouped flow information includes the number of flows per unit time 230, the number of bytes per unit time 240 or the number of packets to be transmitted per second 250.

The traffic check unit 120 functions to check traffic of the collected flow information. When the source IP address belongs to the general group, the traffic check unit 120 determines whether the number of flows per unit time 230, the number of bytes per unit time 240, or the number of packets to be transmitted per second 250 exceeds its corresponding median value.

The traffic respond unit 130 plays a role to suppress the network bandwidth depending on the result of the traffic check. More specifically, when the number of bytes per unit time 240 in a specific source IP address exceeds its median value as a result of the determination from the traffic check unit 120, the traffic respond unit 130 reduces the amount of traffic from the specific source IP address up to its median value under the control of the control unit 140. Further, when the number of flows per unit time 230 in a specific source IP address exceeds its median value as a result of the determination from the traffic check unit 120, the traffic respond unit 130 suppress the generation of new flows from the specific source IP address and reduces the number of existing flows up to the median value under the control of the control unit 140.

Further, when the number of packets to be transmitted per second 250 in a specific source IP address exceeds the median value as a result of the determination of the traffic check unit 120, the traffic respond unit 130 determines whether the number of packets to be transmitted per second in a specific source IP address exceeds a maximum PPS (Packets Per Second) for each source IP address. When it is determined that the number of packets to be transmitted per second exceeds the maximum PPS, the traffic respond unit 130 notices a possibility of occurrence of DDoS (Distributed Denial of Service) attacks and moves the specific source IP address which incurs the excessive packets to the black list group, under the control of the control unit 140. However, when it is determined that the number of packets to be transmitted per second 250 is lower than the maximum PPS, the traffic respond unit 130 reduces the number of packets to be transmitted up to its median value.

Meanwhile, the control unit 140 controls the traffic respond unit 130 not to perform the suppression of the network bandwidth when the source IP address belongs to the white list group. However, when the source IP address belongs to the black list group, the control unit 140 controls the traffic respond unit 130 to block the entrance of traffic into the network.

The network bandwidth allocation apparatus 100 of the embodiment shown in FIG. 1 allocates or control the network bandwidth with respect to the respective the source IP addresses 220 having #1, . . . , #N in order to enhance a balance of the network. In accordance with the embodiment, the control unit 140 may be adapted to use in an environment where one user terminal 210 has one source IP address. However, in a case where one user terminal 210 has several source IP addresses 220 having #1, . . . , #N, the network bandwidth allocation apparatus 100 used for enhancing the network balance sums the bandwidths of the respective source IP addresses 220 having #1, . . . , #N to calculate the bandwidth for the user terminal 210 by integrally combining the bandwidth.

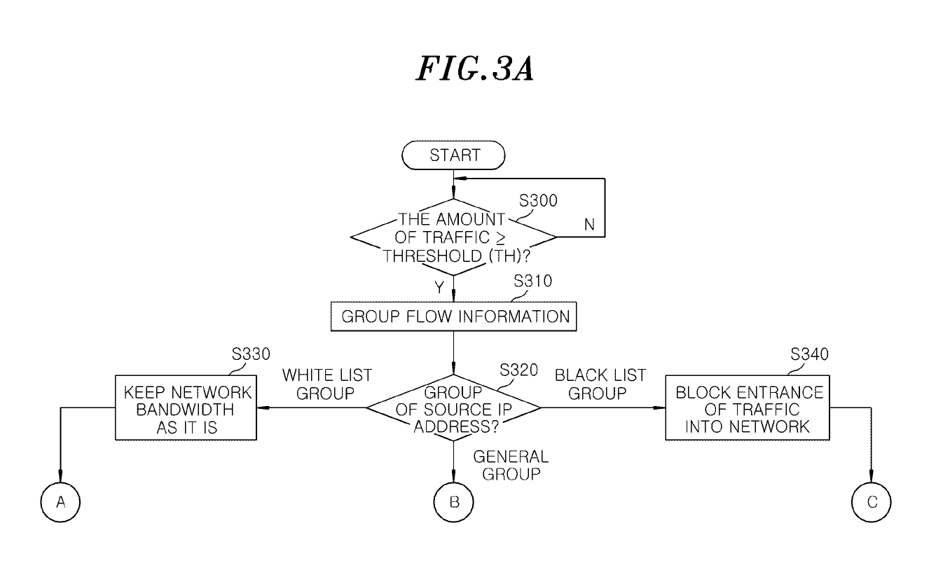

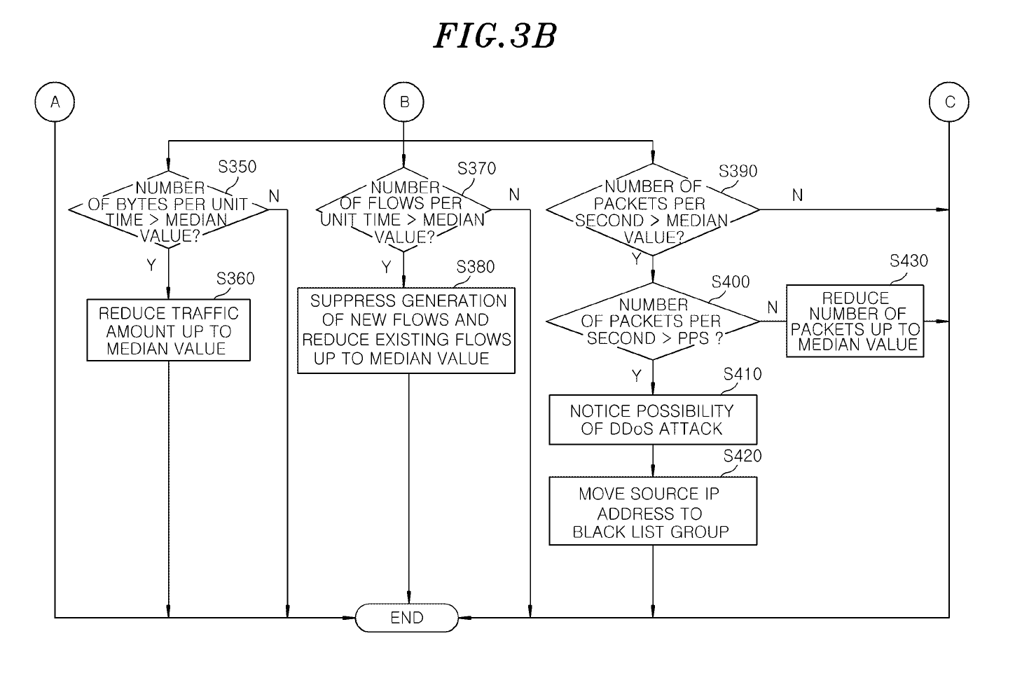

FIGS. 3A and 3B are flow charts illustrating a process of allocating a network bandwidth in a network in accordance with the embodiment of the present invention.

Hereinafter, the process of fairly allocating a network bandwidth in accordance with an embodiment of the present invention will be described with reference to FIGS. 3A and 3B.

First, the control unit 140 determines whether the amount of traffic is more than a predetermined threshold (TH), in an operation S300. When it is determined that the amount of traffic is more than the predetermined threshold (TH), the information collection unit 110 groups the collected flow information on the basis of a source IP address with reference to the collected flow information, in an operation S310.

The information collection unit 110 determines whether the source IP address belongs to which of a white list group, a black list group or a general group, in an operation S320. As a result of the determination, when the source IP address belongs to the white list group, the traffic respond unit 130 does not perform the suppression of the network bandwidth, in an operation S330. Meanwhile, when the source IP address belongs to the black list group, the entrance of traffic into the network is blocked, in an operation S340.

Furthermore, as a result of the determination of the information collection unit 110, when the source IP address belongs to the general group, the traffic check unit 120 determines whether the number of bytes per unit time exceeds its median value, in an operation S350; whether the number of flows per unit time exceeds its corresponding median value, in an operation S370; whether the number of packets to be transmitted per second, in an operation S390.

As a result of the determination of the operation S350, when it is determined that the number of bytes per unit time exceeds its median value, the amount of traffic is reduced up to its median value, in an operation S360. As a result of the determination of the operation S370, when it is determined that the number of flows per unit time exceeds its median value, the generation of new flows from the source IP address which incurs the excessive flows is suppressed and the number of existing flows is reduced up to the median value, in an operation S280. Further, as a result of the determination of the operation S390, when it is determined that the number of packets to be transmitted per second exceeds the median value, it is determined whether the number of packets to be transmitted per second exceeds a maximum PPS for each source IP address, in an operation S400. As a result of the determination of the operation S400, when it is determined that the number of packets to be transmitted per second exceeds the maximum PPS, the traffic respond unit 130 notices the possibility of occurrence of DDoS attacks, in an operation S410, and moves the source IP address which incurs the excessive packets to the black list group, in an operation S420.

Meanwhile, as a result of the determination of the operation S400, when it is determined that the number of packets to be transmitted per second is lower than the maximum PPS, the traffic respond unit 130 reduces the number of packets to be transmitted up to its median value.

The combinations of the each block of the block diagram and each operation of the flow chart attached to the embodiment of the present invention may be performed by computer program instructions. Because the computer program instructions may be loaded on a general purpose computer, a special purpose computer, or a processor of programmable data processing equipment, the instructions performed through the computer or the processor of the programmable data processing equipment may generate the means performing functions described in the each block of the block diagram and each operation of the flow chart. Because the computer program instructions may be stored in a computer using memory or computer readable memory which is capable of intending to a computer or other programmable data processing equipment in order to embody a function in a specific way, the instructions stored in the computer usable memory or computer readable memory may produce a manufactured item involving the instruction means performing functions described in the each block of the block diagram and each operation of the flow chart. Because the computer program instructions may be loaded on the computer or other programmable data processing equipment, the instructions performed by the computer or programmable data processing equipment may provide the operations for executing the functions described in the each block of the block diagram and each operation of the flow chart by a series of functional operations being performed on the computer or programmable data processing equipment.

Moreover, the respective blocks or the respective sequences may indicate modules, segments, or some of codes including at least one executable instruction for executing a specific logical function(s). In several alternative embodiments, is noticed that functions described in the blocks or the sequences may run out of order. For example, two successive blocks and sequences may be substantially executed simultaneously or often in reverse order according to corresponding functions.

While the invention has been shown and described with respect to the embodiments, the present invention is not limited thereto. It will be understood by those skilled in the art that various changes and modifications may be made without departing from the scope of the invention as defined in the following claims.

What is claimed is:

1. An apparatus for allocating a network bandwidth, the apparatus comprising:
an information collection unit configured to collect flow information of a network;
a traffic check unit configured to check traffic of the collected flow information;
a traffic respond unit configured to suppress the network bandwidth depending on a check result of the traffic; and
a control unit configured to the information collection unit, the traffic check unit, and the traffic respond unit.

2. The apparatus of claim 1, wherein the control unit is configured to control the allocation of the network bandwidth when the amount of traffic is more than a predetermined threshold (TH).

3. The apparatus of claim 1, wherein the flow information includes a source IP address, a destination IP address, a source port, a destination port, or a protocol.

4. The apparatus of claim 3, wherein the information collection unit is configured to group the collected flow information on a basis of the source IP address with reference to the collected flow information under a control of the control unit.

5. The apparatus of claim 4, wherein the grouped flow information comprises the number of flows per unit time, the number of bytes per unit time and the number of packets to be transmitted per second.

6. The apparatus of claim 5, wherein the information collection unit is configured to determine whether the source IP address belongs to which of a predetermined white list group, a predetermined black list group, or a general group under the control of the control unit.

7. The apparatus of claim 6, wherein the control unit is configured to:
when the source IP address belongs to the white list group, control the traffic respond unit not to perform the suppression of the network bandwidth.

8. The apparatus of claim 6, wherein the control unit is configured to:
when the source IP address belongs to the black list group, block the entrance of traffic into the network.

9. The apparatus of claim 6, wherein the traffic check unit is configured to:
when the source IP address belongs to the general group, determine whether the number of flows per unit time, the number of bytes per unit time and the number of packets to be transmitted per second exceed its median value under a control of the control unit.

10. The apparatus of claim 9, wherein the traffic respond unit is configured to:
when the number of bytes per unit time exceeds the median value as a result of the determination, reduce the amount of traffic from the source IP address up to the median value under the control of the control unit;
when the number of flows per unit time exceeds the median value as a result of the determination, suppress the generation of new flows from the source IP address while reducing the amount of existing flows up to the median value under the control of the control unit; and
when the number of packets to be transmitted per second exceeds the median value as a result of the determination, determine whether the number of packets to be transmitted per second exceeds a maximum PPS (Packets per Second) for each source IP address.

11. The apparatus of claim 9, wherein the traffic respond unit is configured to:
when the number of packets to be transmitted per second exceeds the maximum PPS for each source IP address, inform the possibility of the occurrence of DDoS (Distributed Denial of Service) attack and move the IP source address to the black list group under the control of the control unit.

12. The apparatus of claim 11, wherein the traffic respond unit is configured to:
when the number of packets to be transmitted per second is lower than the maximum PPS for each source IP address, reduce the number of packets to be transmitted per second up to the median value.

13. A method for allocating a network bandwidth, allocation apparatus, the method comprising:
determining, in a control unit, whether the amount of traffic is more than a predetermined threshold (TH);
grouping, in an information collection unit, flow information on a basis of a source IP address with reference to the flow information; and
determining, in the information collection unit, whether the source IP address belongs to which of a predetermined white list group, a predetermined black list group, or a general group.

14. The method of claim 13, wherein said determining whether the source IP address belongs to which of groups comprises:
when the source IP address belongs to the white list group, keeping the network traffic as it is; and
when the source IP address belongs to the black list group, blocking the entrance of traffic into the network.

15. The method of claim 13, wherein said determining whether the source IP address belongs to which of groups comprises:
when the source IP address belongs to the general group, determining, in the traffic check unit, whether the number of bytes per unit time exceeds its median value; and
determining whether the number of flows per unit time exceeds its median value; and
determining whether the number of packets to be transmitted per second exceeds its median value.

16. The method of claim 15, wherein said determining whether the number of bytes per unit time exceeds its median value comprises:
when the number of bytes per unit time exceeds the median value, reducing the amount of traffic up to the median value.

17. The method of claim 15, wherein said determining whether the number of flows per unit time exceeds its median value comprises:
when the number of flows per unit time exceeds the median value, suppressing the generation of new flows from the source IP address and reducing the number of existing flows up to the median value.

18. The method of claim 15, wherein said determining whether the number of packets to be transmitted per second exceeds its median value comprises:
when the number of packets to be transmitted per second exceeds the median value, determining whether the number of packets to be transmitted per second exceeds a maximum PPS (Packets per Second) for each source IP address.

19. The method of claim 18, wherein said determining whether the number of packets to be transmitted per second exceeds the maximum PPS for each source IP address comprises:
when the number of packets to be transmitted per second exceeds the maximum PPS for each source IP address, informing, in a traffic respond unit, a possibility of occurrence of DDoS (Distributed Denial of Service) attacks and moving the source IP address, which incurs the excessive traffic, to the black list group.

20. The method of claim 18, wherein said determining whether the number of packets to be transmitted per second exceeds the maximum PPS for each source IP address comprises:
when the number of packets to be transmitted per second is lower than the maximum PPS for each source IP address, reducing the number of packets to be transmitted to the median value up to the median value.
